(19) United States
(12) Patent Application Publication
(10) Pub. No.: US 2006/0124275 A1
(43) Pub. Date: Jun. 15, 2006

(54) Power supply system for a motor vehicle

(75) Inventors: Markus Gosse, Keller, TX (US); Thomas Heckenberger, Leinfelden-Echterdingen (DE); Dieter Heinle, Pludershausen (DE); Dieter Schmadl, Marbach (DE)

Correspondence Address: FOLEY AND LARDNER LLP;SUITE 500, 3000 K STREET NW, WASHINGTON, DC, 20007, US

(73) Assignee: BEHR GmbH & CO KG

(21) Appl. No.: 10/545,890

(22) PCT Filed: Feb. 18, 2004
(86) PCT No.: PCT/EP04/01535

§ 371 Date: Aug. 17, 2005

(30) Foreign Application Priority Data
Feb. 18, 2003 (DE) 10306715.9

(51) Int. Cl. B60H 3/00; B61D 27/00

(52) U.S. Cl. 165/42; 165/43

(57) ABSTRACT

The invention relates to an air-conditioning system for a motor vehicle. According to the invention, an accessory drive is provided for supplying power to the air-conditioning system, particularly to an auxiliary air-conditioning system for a motor vehicle. The accessory drive generates heat and/or mechanical power and/or electrical power.

The invention relates to a power supply system for motor vehicles according to the preamble of the patent claims.

Known power supply systems for vehicles employ, for example for auxiliary air conditioning, independent appliances which are fuel-operated and which require a high outlay in terms of integration in the vehicle. For auxiliary cooling, auxiliary motors are sometimes used, which drive a compressor in a specific separate refrigerant circuit. Sometimes, the actual vehicle engine is also operated, when stationary, thus entailing high costs and being detrimental to the environment. Another solution makes use of a cold store for auxiliary cooling. In this case, the limited storage capacity and the relatively high construction volume are to be considered as disadvantages.

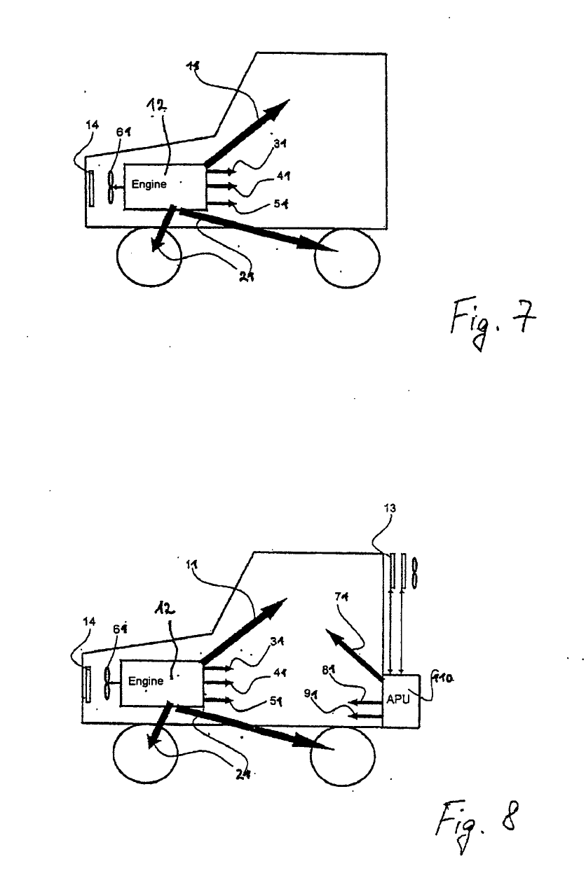

FIG. 7, for example, shows diagrammatically a motor vehicle in which an engine 12 supplies power not only to a single-axle or multiaxle vehicle drive 21, but also, via a coolant, to cab heating 11 and, via mechanical coupling, to secondary assemblies 31, such as, for example, booster pumps, hydraulic pumps, a water pump or a compressed-air compressor. The auxiliary drives can also be operated electrically, power being supplied by a generator 41 coupled mechanically to the engine and having a battery as a store. Furthermore, the engine 12 drives an air-conditioning system compressor 51 and a fan 61 for a radiator 14 via suitable couplings and/or belt drives.

A further example of a motor vehicle is illustrated in FIG. 8. Here, an auxiliary assembly 110 serves additionally for power supply when the engine 12 is at a standstill. By means of the auxiliary assembly 110, for example, heating heat 71, air conditioning 81 and/or power 91 for the vehicle are provided. There is the disadvantage of an additional installation of generators, air-conditioning compressors, air-conditioning condensers with a specific fan 13, and power or other supply lines.

Further possible disadvantages in the systems known from the prior art are high system complexity, separate systems for heating and cooling in the vehicle, a high weight and construction volume, high costs, environmental pollution due to noise and exhaust gases, and a limited period of use.

An object of the present invention is to specify an air-conditioning system which avoids one or more of the disadvantages listed.

The object is achieved, according to the invention, by means of an air-conditioning system having the features of patent claim 1.

The dependent patent claims relate to advantageous refinements and developments of the invention.

A fundamental idea of the invention is that power supply is ensured by means of an auxiliary drive, the auxiliary drive generating, for example, heat and/or mechanical energy and/or electrical energy.

According to an advantageous embodiment of the auxiliary drive, the heat is generated by means of a burner, and a working fluid, for example a coolant, is heated. The heated working fluid is then used, for example, for preheating a motor vehicle engine and/or for heating a vehicle interior, in which case, to heat the vehicle interior, the working fluid is conducted through a radiator which, for example, may be part of an air-conditioning system already present in the motor vehicle.

In an advantageous development of the invention, the auxiliary drive generates the electrical energy by means of a generator which is coupled to the auxiliary drive.

In a particularly advantageous embodiment of the invention, the auxiliary drive is used additionally or alternatively for cooling a vehicle interior, in that the auxiliary drive supplies power to a refrigerant circuit with an evaporator, with a compressor and with a condenser.

For the supply of energy to a refrigerant circuit, the auxiliary drive makes mechanical and/or electrical energy available, for example, for driving the compressor.

In a particularly advantageous development of the power supply system according to the invention, components from the refrigerant circuit already present in the motor vehicle are used for auxiliary air conditioning. Thus, for example, an evaporator and/or a condenser and/or a compressor, which are parts of the refrigerant circuit already present in the motor vehicle and therefore of an existing air conditioning system, may also be used for auxiliary air conditioning. The compressor is equipped with a coupling for such an application, so that, in normal operation, it is driven by the motor vehicle engine and, in auxiliary air-conditioning operation, is driven by the auxiliary drive. In principle, however, it is also possible for the compressor to be driven by the auxiliary drive even in normal operation, in which case the coupling may be dispensed with.

Where an air-conditioning system already present in the motor vehicle is concerned, the corresponding air-conditioning appliance may advantageously also be used for temperature determination and/or air mixing and/or air distribution for the vehicle interior in auxiliary air-conditioning operation. This also applies to a control unit and/or to an operating unit.

In a further embodiment of the invention, the auxiliary drive may be designed as a fuel cell. Additionally or alternatively, the auxiliary drive may comprise means for the generation of steam, from which mechanical energy can be obtained in a closed steam circuit, fuels being burnt, without an open flame, in a thermal reactor, which comprises porous ceramic structures, for steam generation. Combustion in such a thermal reactor advantageously takes place with only a small quantity of exhaust gas, without vibrations and virtually without any disturbing noises. Moreover, it is possible to use various types of fuels, such as gasoline, diesel, gas, biofuel, etc.

According to one embodiment, the at least one vehicle component is suitable, in particular alone, for supplying the motor vehicle during the operation and during a standstill of an engine. This, under certain circumstances, avoids a multiple installation of components, their supply lines, etc. The vehicle component is in this case, in particular, a heating and/or air-conditioning device, a booster pump, a hydraulic pump, a water pump, a compressed-air compressor, a fan and/or a current producer, such as a generator.

Exemplary embodiments of the invention are illustrated in the drawing and are described in more detail below. In the drawing:

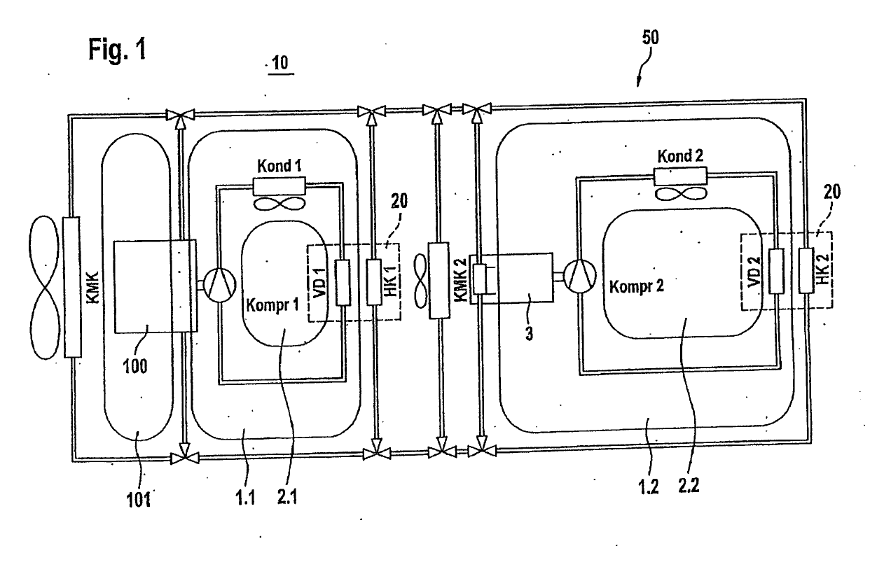

FIG. 1 shows a block diagram of a first exemplary embodiment of an air-conditioning system according to the invention for a motor vehicle;

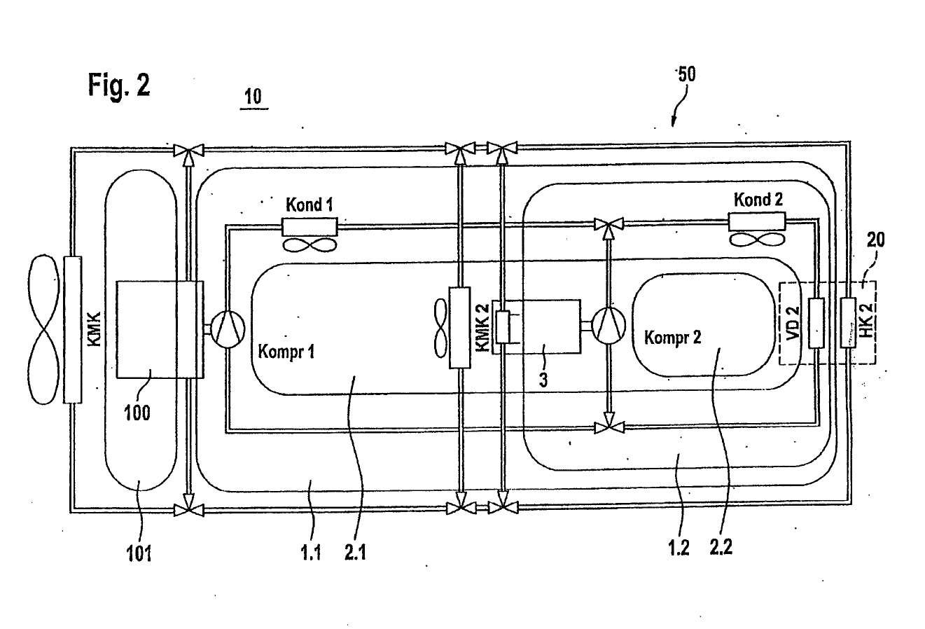

FIG. 2 shows a block diagram of a second exemplary embodiment of an air-conditioning system according to the invention for a motor vehicle;

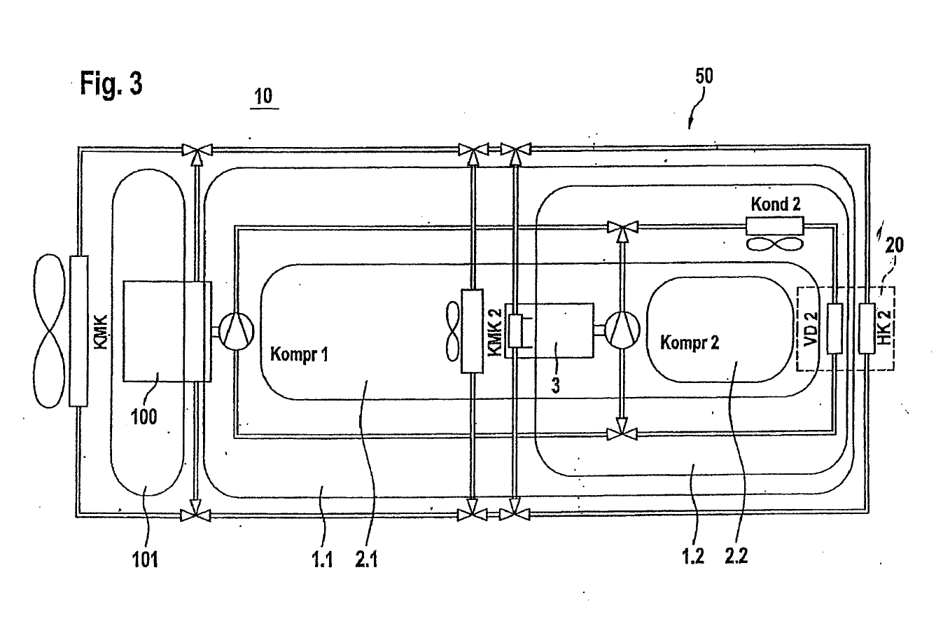

FIG. 3 shows a block diagram of a third exemplary embodiment of an air-conditioning system according to the invention for a motor vehicle;

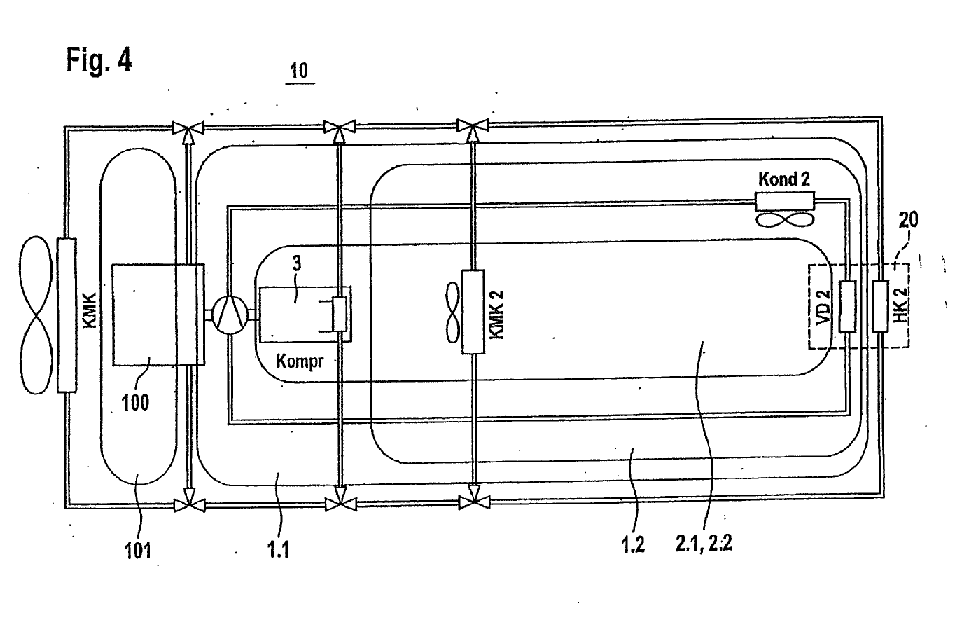

FIG. 4 shows a block diagram of a fourth exemplary embodiment of an air-conditioning system according to the invention for a motor vehicle;

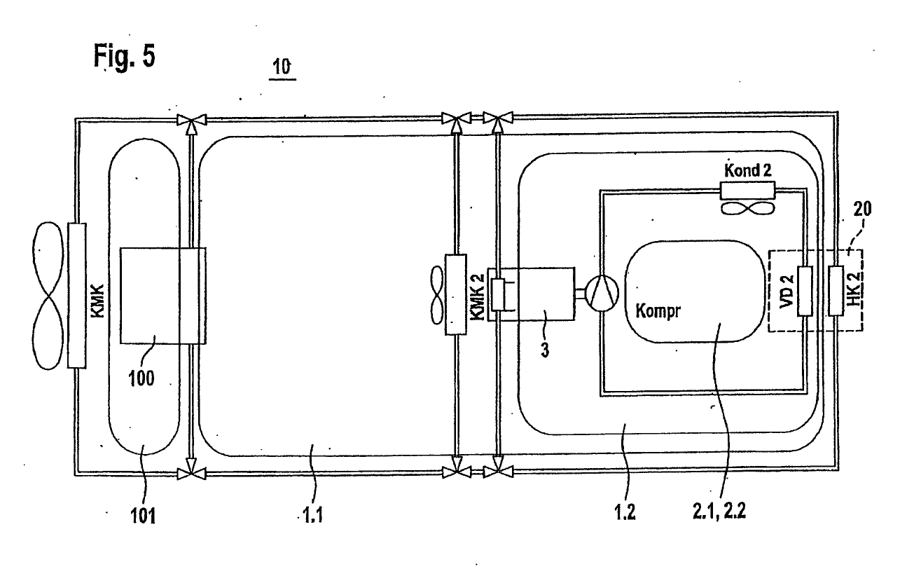

FIG. 5 shows a block diagram of a fifth exemplary embodiment of an air-conditioning system according to the invention for a motor vehicle;

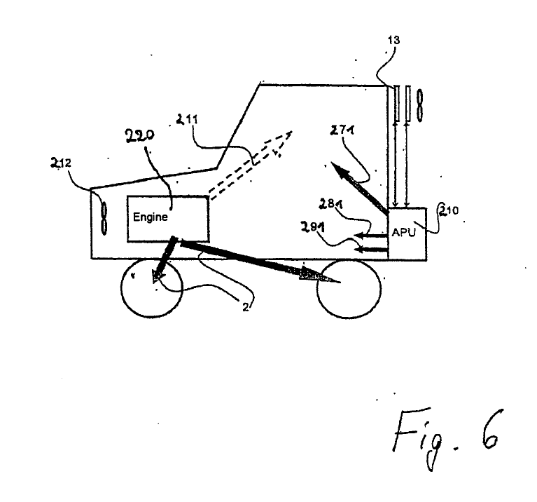

FIG. 6 shows a motor vehicle with a power supply system according to the invention;

FIG. 7 shows a motor vehicle according to the prior art, and

FIG. 8 shows a motor vehicle according to the prior art.

Various exemplary embodiments are described below with reference to FIG. 1 to FIG. 4, the same reference symbol being used for identical or similar components in the exemplary embodiments.

FIG. 1 shows an air-conditioning system 10 according to the invention, with a refrigerant circuit 101 having a first heat exchanger KMK, which is designed, for example, as a coolant radiator, for a motor vehicle engine 100 having a first heating circuit 1.1 and a second heating circuit 1.2 and also a first and a second cooling circuit 2.1 and 2.2. The first heating circuit 1.1 comprises a second heat exchanger HK1, which is designed, for example, as a radiator, for heating a vehicle interior. The second heating circuit 1.2 comprises an auxiliary drive 3 and a third heat exchanger HK2, which is designed, for example, as a radiator, for heating a vehicle interior. In addition, in the exemplary embodiment illustrated, for cooling the auxiliary drive 3 there is an eighth heat exchanger KMK2, which is designed, for example, as a coolant cooler and can be connected to the second heating circuit 1.2. The two heating circuits 1.1 and 1.2 preferably use as working fluid the same coolant as the coolant circuit 101. The coolant circuits 1.1, 1.2 and 101 additionally comprise the lines, illustrated in FIG. 1, and valves for controlling the circuits. Thus, the second heating circuit 1.2 may, for example, also be coupled to the first heating circuit 1.1 for engine preheating via corresponding lines and valves.

The first cooling circuit 2.1 comprises a first compressor Kompr1 which, in the exemplary embodiment illustrated, is driven by the motor vehicle engine 100, a fourth heat exchanger VD1, which is designed, for example, as an evaporator, and a fifth heat exchanger Kond1, which is designed, for example, as a condenser. The second cooling circuit 2.1 comprises a second compressor Kompr2 which, in the exemplary embodiment illustrated, is driven by the auxiliary drive 3, a sixth heat exchanger VD2, which is designed, for example, as an evaporator, and a seventh heat exchanger Kond2, which is designed, for example, as a condenser. The two cooling circuits 2.1 and 2.2 comprise the connecting lines, illustrated in FIG. 1, for transporting a corresponding refrigerant.

In the example illustrated, when the vehicle is operating normally, the first heating circuit 1.1 and the first cooling circuit 2.1 are used for the air-conditioning of the vehicle interior. In auxiliary air-conditioning operation, the second heating circuit 1.2 and the second cooling circuit 2.2, which are components of an auxiliary air-conditioning system 50, are used for the air-conditioning of the vehicle interior, the second heating circuit 1.2 also being connectable to the first heating circuit 1.1 for preheating the vehicle engine 100.

The components of the auxiliary air-conditioning system 50 may, of course, also be used, while the vehicle is operating normally, in addition to the components of the first heating circuit 1.1 and of the first cooling circuit 2.1. As is also evident from FIG. 1, in the exemplary embodiment illustrated the second heat exchanger HK1, the third heat exchanger HK2, the fourth head exchanger VD1 and the sixth heat exchanger VD2 are arranged in a common air-conditioning apparatus 20 for the air-conditioning of the vehicle interior. Thus, advantageously, the same air mixing and air distribution devices, not illustrated, of the air-conditioning apparatus 20 can be used in both operating modes for the air-conditioning of the vehicle interior.

FIG. 2 shows a second exemplary embodiment of the air-conditioning system 10 according to the invention which is a modification of the first exemplary embodiment. As is evident from FIG. 2, the first and the second heating circuit 1.1 and 1.2 use the third heat exchanger HK2 for heating the vehicle interior. In the exemplary embodiment illustrated, the second heat exchanger HK1 has been dispensed with. As is also evident from FIG. 2, the first and the second cooling circuit 2.1 and 2.2 use the sixth heat exchanger VD2. In the exemplary embodiment illustrated, the fourth heat exchanger VD1 has been dispensed with. Functioning is similar to that described with reference to FIG. 1, except that, in the exemplary embodiment according to FIG. 2, the third and the sixth heat exchanger HK2, VD2 are used both in normal operation and in auxiliary air-conditioning operation.

In the exemplary embodiment illustrated in FIG. 3, a further reduction in the number of components is evident, and in this case, also, only one condenser Kond2 is used in both cooling circuits 2.1 and 2.2. The cooling circuits 1.1, 1.2 and 101 are unchanged, as compared with the embodiment illustrated in FIG. 2.

In the exemplary embodiment illustrated in FIG. 4, the two cooling circuits 2.1, 2.2 are combined into one cooling circuit which uses only one compressor Kompr. The remaining compressor Kompr is in this case driven via a corresponding coupling by the vehicle engine 100 in normal operation and by the auxiliary drive 3 in auxiliary air-conditioning operation. The coolant circuits 1.1, 1.2 and 101 are unchanged, as compared with the embodiment illustrated in FIG. 2.

FIG. 5 shows an exemplary embodiment in which the power for cooling the vehicle interior both in normal operation and in auxiliary air-conditioning operation is made available by the auxiliary drive 3. Only the heat energy for heating the vehicle interior is made available by the vehicle engine 100 and/or by the auxiliary drive 3 via the two heating circuits 1.1 and 1.2.

The auxiliary drive may in this case be designed as a fuel cell and/or as a closed steam circuit and/or as an internal combustion engine which is improved, as compared with the conventional internal combustion engines described, in terms of environmental pollution caused by noise and exhaust gases.

FIG. 6 shows diagrammatically a motor vehicle, the power supply system of which is designed in such a way that an auxiliary assembly 210 can be operated even during the operation of an engine 220. As a result, for example, heating heat 271, air conditioning 281 and/or current 291 for the vehicle are provided, for which purpose the power supply system for the vehicle needs to have only exactly one heating circuit, cooling/air-conditioning circuit or current generator. Some or all of the energy-consuming assemblies may be driven by the auxiliary assembly 210 mechanically or electrically by means of the generator 291. If the auxiliary drive, such as an auxiliary assembly, has sufficient electrical power, an electrification of the fan 212 is also possible, so that the latter can be controlled and regulated according to requirements.

A cab heating 211 fed by the engine 220 saves energy under certain circumstances, since the waste heat from the engine is available in any case. Cab heating by means of the auxiliary assembly is then advantageous, furthermore, as an auxiliary function or else to give assistance during driving, such assistance, under certain circumstances, being desirable, particularly in the case of high-efficiency engines.

1. A power supply system for a motor vehicle, in particular with an air-conditioning system and/or auxiliary air-conditioning system, characterized by an auxiliary drive for supply of power to at least one vehicle component, in particular the air-conditioning system, the auxiliary drive generating heat and/or mechanical energy and/or electrical energy.

2. The power supply system as claimed in claim 1, characterized in that the auxiliary drive generates the heat by means of a burner for heating a working fluid.

3. The power supply system as claimed in claim 1, characterized in that the heated working fluid is used for preheating a motor vehicle engine and/or for heating a vehicle interior.

4. The power supply system as claimed in claim 3, characterized in that, to heat the vehicle interior, the working fluid is conducted through a radiator of an auxiliary air-conditioning system.

5. The power supply system as claimed in claim 4, characterized in that the radiator is part of a heating circuit already present in the motor vehicle.

6. The power supply system as claimed in claim 1, characterized in that the auxiliary drive generates the electrical energy by means of a generator.

7. The power supply system as claimed in claim 1, characterized in that, to cool a vehicle interior, the auxiliary drive supplies power to a cooling circuit of the auxiliary air-conditioning system with an evaporator, with a compressor and with a condenser.

8. The power supply system as claimed in claim 7, characterized in that the auxiliary drive makes the power for the cooling circuit available in the form of mechanical and/or electrical energy for the compressor.

9. The power supply system as claimed in claim 7, characterized in that the evaporator is part of a refrigerant circuit already present in the motor vehicle.

10. The power supply system as claimed in claim 7, characterized in that the condenser is part of the refrigerant circuit already present in the motor vehicle.

11. The power supply system as claimed in claim 7, characterized in that the compressor is part of the refrigerant circuit already present in the motor vehicle.

12. The power supply system as claimed in claim 11, characterized in that the compressor is driven via a coupling by the motor vehicle engine in normal operation and by the auxiliary drive in auxiliary air-conditioning operation.

13. The power supply system as claimed in claim 10, characterized in that the compressor is driven by the auxiliary drive in normal operation and in auxiliary air-conditioning operation.

14. The power supply system as claimed in claim 3, characterized by an air-conditioning apparatus for the auxiliary air-conditioning system for temperature determination and/or air mixing and/or air distribution for the vehicle interior.

15. The power supply system as claimed in claim 14, characterized in that the air-conditioning apparatus comprises a control unit and/or an operating unit.

16. The power supply system as claimed in claim 14, characterized in that the air-conditioning apparatus is part of an air-conditioning system already installed in the vehicle.

17. The power supply system as claimed in claim 1, characterized in that the auxiliary drive is designed as a fuel cell.

18. The power supply system as claimed in claim 1, characterized in that the auxiliary drive comprises means for the generation of steam, from which the mechanical energy is obtained.

19. The power supply system as claimed in claim 18, characterized in that the steam is generated as a result of the combustion of fuels in a thermal reactor.

20. The power supply system as claimed in claim 1, characterized in that the at least one vehicle component is suitable, in particular alone, for supplying the motor vehicle during the operation and during a standstill of an engine.

21. The power supply system as claimed in claim 1, characterized in that the at least one vehicle component is a heating and/or air-conditioning device, a booster pump, a hydraulic pump, a water pump, a compressed-air compressor, a fan and/or a current generator.
